(19) United States
(12) Patent Application Publication
(10) Pub. No.: US 2009/0147228 A1
(43) Pub. Date: Jun. 11, 2009

(54) Exposure apparatus, manufacturing method thereof, and maintenance method of exposure apparatus

(75) Inventors: Kazuya Ono, Saitama-shi (JP); Toshimasa Shimoda, Ageo-shi (JP); Yoichi Arai, Honjyo-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/314,411

(22) Filed: Dec. 10, 2008

Related U.S. Application Data
(60) Provisional application No. 60/996,929, filed on Dec. 11, 2007.

(51) Int. Cl. G03B 27/42

(52) U.S. Cl. 355/53

(57) ABSTRACT

A projection optical system PL is used to project an image of a pattern. A manufacturing method of an exposure apparatus includes: a positioning step of positioning the projection optical system at a predetermined position; and a support step of supporting the positioned projection optical system. The positioning step includes a step of moving the projection optical system upward from below at the time of positioning.

### CROSS-REFERENCE TO RELATED APPLICATION

This application is a non-provisional application claiming priority to and the benefit of U.S. provisional application No. 60/996,929, filed Dec. 11, 2007. The entire contents of which are incorporated herein by reference.

### BACKGROUND

1. Field of the Invention

The present invention relates to an exposure apparatus and a manufacturing method thereof, and a maintenance method of the exposure apparatus.

2. Description of Related Art

When semiconductor elements or the like are manufactured, a projection exposure apparatus is used which transfers art image of a pattern of a reticle as a mask onto the respective shot regions on a wafer (or a glass plate, or the like), as a substrate, on which a resist is coated via a projection optical system. Conventionally, as a projection exposure apparatus, a step-and-repeat type (static exposure type) projection exposure apparatus (stepper) is heavily used. However, recently, a scan-exposure type projection exposure apparatus (scan type exposure apparatus) such as on a step and scan system which performs exposure while scanning a reticle and a wafer synchronously with a projection optical system also has become the focus of attention.

In the conventional exposure apparatus, there are fixed onto a structure which supports a projection optical system: a reticle stage which supports and transports a reticle as a master pattern and a wafer onto which the pattern thereof is transferred; and a drive portion of a wafer stage. In addition, the projection optical system is also fixed onto the structure at a portion in the vicinity of its center of gravity. Furthermore, in order to position a wafer stage with high accuracy, the position of the wafer stage is measured by a laser interferometer. On the wafer stage, there is attached a movement mirror for the laser interferometer.

As described above, in the conventional exposure apparatus, the drive portion such as the wafer stage and the projection optical system are fixed onto the same structure. Therefore, vibration generated by the drive reaction force of the stage is transmitted to the structure, and is also transmitted to the projection optical system. All the mechanical structures mechanically resonate in response to vibration with a given frequency. Therefore, when such vibration reaches the structure, deformation or resonance of the structure is produced, thus it brings a displacement of a transfer pattern image or of a lowering of contrast.

Therefore, PCT International Publication No. WO 06/038952 discloses a technique of suppressing vibration transmitted to a projection optical system by means of a comparatively simple mechanism that includes: a support member for supporting the projection optical system; and a link member for suspend-supporting the projection optical system on a frame via a support member with a flexible structure.

In the manufacture of an exposure apparatus, when a projection optical system is to be installed by insertion from above a frame, large-scale transport equipment such as heavy machinery is required to move the projection optical system that weighs as much as tons. As a result, the installation of the projection optical system may take a lot of effort and cost.

Furthermore, when a long projection optical system is inserted from above, it is required to secure a high ceiling in a building where the exposure apparatus is installed. As a result the constrained condition for the building may become more tighten. The problems as described above may lead to similar problems when the projection optical system is moved out from the exposure apparatus for the purpose of maintenance and the like, in addition to installation and positioning of the projection optical system.

A purpose of some aspects of the present invention is to provide an exposure apparatus, a manufacturing method thereof, and a maintenance method of the exposure apparatus, that allows easy carrying in and out of a projection optical system

### SUMMARY

In accordance with a first aspect of the present invention, there is provided a manufacturing method of an exposure apparatus that uses a projection optical system to project an image of a pattern, the method comprising: upwardly moving the projection optical system to position the projection optical system at a predetermined position; and supporting the positioned projection optical system.

According to the manufacturing method of an exposure apparatus, it allows easy carrying in and out of a projection optical system.

In accordance with a second aspect of the present invention, there is provided a maintenance method of an exposure apparatus that uses a projection optical system to project an image of a pattern, the method comprising uninstalling the projection optical system from the exposure apparatus, the un-installation comprising downwardly moving the projection optical system supported by a support member.

According to the maintenance method of an exposure apparatus, it allows easy carrying in and out of a projection optical system.

In accordance with a third aspect of the present invention, there is provided an exposure apparatus that uses a projection optical system to project an image of a pattern, comprising: a support structure that supports a projection optical system; and an opening portion via which the projection optical system is carried out in a horizontal direction, the opening portion being located lower than the projection optical system supported by the support structure.

According to the exposure apparatus, it allows easy carrying in and out of a projection optical system

### BRIEF DESCRIPTION OF THE DRAWINGS

FIG. 1 is a schematic block diagram showing an exposure apparatus according to an embodiment.

FIG. 2 schematically shows an internal configuration of a light source, an illumination optical system, and a projection optical system.

FIG. 3A schematically shows an exemplary configuration of the optical integrator of FIG. 2.

FIG. 3B schematically shows an exemplary configuration of the optical integrator of FIG. 2.

FIG. 4 is a diagram for schematically explaining one scan exposure in the present embodiments.

FIG. 5 shows how a rotation axis of an arc shape in an illumination region formed on a mask is defined as a center of a circle that defines an outer arc or an inner arc.

FIG. 6 shows a procedure of positioning a projection optical system at an exposure position.

FIG. 7 shows a procedure of positioning the projection optical system at the exposure position.

FIG. 8 is a planar cross-sectional view showing an exposure apparatus according to a second embodiment.

FIG. 9 is a planar cross-sectional view showing the exposure apparatus according to the second embodiment.

FIG. 10 is a schematic block diagram showing the exposure apparatus according to the second embodiment

FIG. 11 is a flow chart showing one example of manufacturing steps of a micro device.

FIG. 12 shows one example of detailed steps of the step S13 in FIG. 11.

### DESCRIPTION OF EMBODIMENTS

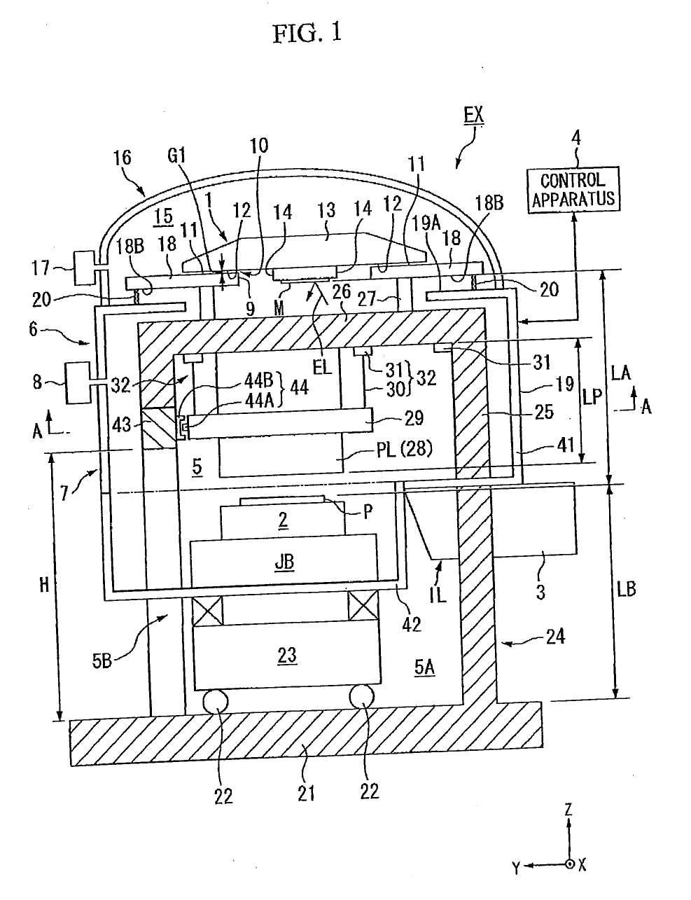

Hereunder is a description of embodiments of an exposure apparatus according to the present invention and a manufacturing method thereof, and a maintenance method of the exposure apparatus, with reference to FIG. 1 to FIG. 12.

In the following description, a predetermined direction within a horizontal plane is made the X axis direction, a direction orthogonal to the X axis direction within the horizontal plane is made the Y axis direction, and a direction orthogonal to both the X axis direction and the Y axis direction (that is, a perpendicular direction) is made the Z axis direction. Furthermore, rotation (inclination) directions about the X axis, the Y axis and the Z axis, are made the θX, the θY, and the θZ directions respectively.

### First Embodiment

FIG. 1 is a schematic block diagram showing an exposure apparatus EX according to a first embodiment. In the present embodiment, the case where the exposure apparatus EX is one which exposes a substrate P with extreme ultraviolet (EUV) light will be described as an example. Extreme ultraviolet light is an electromagnetic wave in a soft X-ray region at a wavelength of for example approximately 5 to 50 nm. In the following description, extreme ultraviolet light is appropriately referred to as EUV light. As one example, in the present embodiment, EUV light at a wavelength of 13.5 nm is used as exposure light (illumination light) EL.

First, an outline of the exposure apparatus EX according to the present embodiment will be described.

In FIG. 1, the exposure apparatus EX includes: a mask stage (mask holding apparatus) 1 capable of moving while holding a mask M on which a pattern is formed; a substrate stage (substrate holding apparatus) 2 capable of moving while holding a substrate P; a light source apparatus 3 for generating illumination light; an illumination optical system IL for guiding the illumination light from the light source apparatus 3 to the mask M to illuminate the mask M; a projection optical system PL for projecting exposure light EL including information on an image of the pattern of the mask M illuminated with the illumination light onto the substrate P; and a control apparatus 4 for controlling operation of the whole exposure apparatus EX. The substrate P can be provided with sensitivity in which a film of a sensitive material (photoresist) or the like is formed on a surface or various types of membrane such as a protective membrane (top coat membrane) in addition to a photosensitive membrane is coated on a surface of a base material such as a semiconductor wafer such as a silicon wafer. The mask M can be a reticle formed with a device pattern which is to be projected onto the substrate P.

The musk M is a reflecting mask with a multilayer film capable of reflecting the EUV light. The exposure apparatus EX illuminates with the illumination light (EUV light) the surface (reflecting surface) of the mask M where the pattern is formed with the multilayer film, and exposes the substrate P having sensitivity with the exposure light EL reflected off the mask M.

The exposure apparatus EX of the present embodiment includes a chamber apparatus 6 capable of setting a first space 5 through which the illumination light and the exposure light EL travel into an environment in a predetermined state. The chamber apparatus 6 includes: a first space formation member 7 for forming the first space 5 through which the exposure light EL travels; and a first adjusting apparatus 8 for adjusting the environment of the first space 5.

In the present embodiment, the first adjusting apparatus 8 includes a vacuum system, and adjusts the first space 5 to a vacuum state. The control apparatus 4 uses the first adjusting apparatus 8 to adjust the first space 5 through which the illumination light and the exposure light EL travel to a substantially vacuum state. As one example of a vacuum state, in the present embodiment, the pressure of the first space 5 is adjusted to a reduced pressure atmosphere of approximately 1×10⁻⁴ Pa. Note that a value of the pressure set in this first space 5 is appropriately described as a first pressure value.

The illumination light emitted from the light source apparatus 3 travels through the first space 5. In the first space 5, there are arranged at least a part of an illumination optical system IL and a projection optical system PL, in the present embodiment. The illumination light emitted from the light source apparatus 3 passes through the illumination optical system IL arranged in the first space 5 to illuminate the mask M. Then, it is transformed into the exposure light EL that includes information on the image of the pattern of the mask M and passes through the projection optical system PL. Furthermore, in the present embodiment, the substrate stage 2 is arranged in the first space 5.

In the description of the embodiments, the EUV light from the light source apparatus 3 until it illuminates the mask M is referred to as the illumination light, and the EUV light from reflection off the mask M to projection onto the substrate P is referred to as the exposure light EL. However, this nominal distinction is used for convenience of description, and both may be treated as the exposure light EL.

The first space formation member 7 has: a first opening 9; and a first surface 11 provided around the first opening 9. The first opening 9 is formed at a position allowing the illumination light having traveled through the first space 5 to be incident Furthermore, in the present embodiment, the first opening 9 is formed at a position allowing the illumination light emitted from the illumination optical system IL to be incident.

It is configured such that the mask stage 1 moves the mask 1 while holding the mask 1. The mask stage 1 is arranged so as to cover the first opening 9. The mask stage 1 has a second surface 12 that faces the first surface 11 provided on the first space formation member 7 (guide member 18). This second surface 12 is capable of relative movement between itself and the first opening 9 while being guided by the first surface 11. In the present embodiment there is formed a gas sealing mechanism 10 between the first surface 11 of the first space formation member 7 and the second surface 12 of the mask stage 1. At this time, there is formed a predetermined gap G1 between the first surface 11 and the second surface 12. The gap G1 is adjusted to a predetermined amount (for example approximately 0.1 to 1 μm). This suppresses flow of gas to the inside of the first space 5 via the gap G1. In the present embodiment the first opening 9 is covered with the mask stage 1, and the gas sealing mechanism 10 is formed between the first surface 11 and the second surface 12 as described above, to thereby bring the first space 5 into a substantially hermetic state. As a result, the chamber apparatus 6 is capable of controlling the first space 5 in a predetermined state (vacuum state).

The mask stage 1 holds the mask M so that the mask M is arranged in the first space 5 via the first opening 9. In the present embodiment, the mask stage 1 is arranged on the +Z side of the first space 5, and holds the mask M so that a reflecting surface of the mask M faces the −Z side (the first space 5 side). Furthermore, in the present embodiment, the mask stage 1 holds the mask M so that the reflecting surface of the mask M and the XY plane are substantially parallel to each other. The illumination light emitted from the illumination optical system IL is irradiated onto the reflecting surface of the mask M held in the mask stage 1.

The mask stage 1 will be described in further detail. The mask stage 1 includes: a first stage 13 which is larger than the first opening 9 and on which the second surface 12 is formed, the first stage 13 being configured to be movable with respect to the first surface 11 and the first opening 9; and a second stage 14 which is smaller than the first opening 9 and which is configured to be movable with respect to the first stage 13 while holding the mask M. The first stage 13 is arranged so as to cover the first opening 9, and the gas sealing mechanism 10 is formed between the second sure 12 of the first stage 13 and the first surface 11 of the first space formation member 7. The first stage 13 is movable with respect to the first surface 11 and the first opening 9 while being guided by the first surface 11. The second stage 14 is arranged on the −Z side (the first space 5 side) of the first stage 13. The mask M held in the second stage 14 is arranged in the first space 5 via the first opening 9. The second stage 14 is movable with respect to the first stage 13 while holding the mask M. With such a configuration, it is possible for the first stage 13 to function as a rough movement stage for moving the mask M and for the second stage 14 to function as a fine movement stage for moving the mask M. Note that the first stage 13 and the second stage 14 each have a driving apparatus for moving the corresponding stage which is not shown in the figure.

Furthermore, the chamber apparatus 6 includes: a second member 16 for forming a second space 15 between itself and an outer surface of the first space formation member 7; and a second adjusting apparatus 17 for adjusting an environment of the second space 15. The second space 15 accommodates at least a part of the mask stage 1 (for example, the first stage 13 or the like). In the present embodiment, there is airspace outside the first space 5 and the second space 15. The pressure thereof is atmospheric pressure. The second adjusting apparatus 17 adjusts the pressure of the second space 15 to be higher than that of the first space 5 and lower than that of the atmospheric pressure. As one example, in the present embodiment, the pressure of the second space 15 is adjusted to be a reduced pressure atmosphere of approximately 1×10⁻¹ Pa. Note that a value of the pressure set in this second space 15 is appropriately called a second pressure value.

With the configuration described above, at least a part of the mask stage 1 is arranged in the second space 15, and the mask M held in the mask stage 1 is arranged in the first space 5.

The exposure apparatus EX is a scanning type exposure apparatus (so-called scanning stepper) which projects the image of the pattern of the mask M onto the substrate P while synchronously moving the mask M and the substrate P in a predetermined scanning direction. In the present embodiment, the scanning direction (synchronous movement direction) of the mask M is made the Y axis direction, and the scanning direction (synchronous movement direction) of the substrate P is also made the Y axis direction. While moving shot regions of the substrate P in the Y axis direction with respect to a projection region of the projection optical system PL and also moving a pattern formation region of the mask M in the Y axis direction with respect to an illumination region of the illumination optical system IL in synchronous with the movement in the Y axis direction of the shot regions of the substrate P, the exposure apparatus EX illuminates the mask M with the exposure light EL, and irradiates the exposure light EL from the mask M onto the substrate P to expose the substrate P.

The first stage 13 of the mask stage 1 has a comparatively long stroke in the Y axis direction (scanning direction) so that the whole of the pattern formation region of the mask M passes through the illumination region of the illumination optical system IL during the scanning exposure of one of the shot regions on the substrate P. With the movement in the Y axis direction of the first stage 13, the second stage 14 supported by the first stage 13 is also moved in the Y axis direction together with the first stage 13. As a result, with the movement in the Y axis direction of the first stage 13, the mask M held in the second stage 14 is also moved in the Y axis direction together with the first stage 13. The second stage 14 is finely movable with respect to the first stage 13, and is configured to move with a stroke shorter than that of the first stage 13. Furthermore, it may be configured such that the second stage 14 is movable with a small stroke also in the X axis direction with respect to the first stage 13.

Furthermore, the gas sealing mechanism 10 is formed between the first surface 11 of the first space formation member 7 and the second surface 12 of the first stage 13. Therefore, even in the case where the first stage 13 is moved with respect to the first space formation member 7, flow of the gas to the inside of the first space 5 is suppressed Furthermore, the present embodiment is provided with a gap adjustment mechanism for adjusting the gap G1 between the first surface 11 and the second surface 12. Therefore, even in the case where the first stage 13 is being moved with respect to the first space formation member 7, the gap G1 between the first surface 11 and the second surface 12 is maintained at a predetermined amount.

As a result, even in the case where the first stage 13 is moved with respect to the first space formation member 7, flow of the gas to the inside of the first space 5 is suppressed.

The first space formation member 7 includes: a guide member 18 on which a first surface 11 is formed; and a chamber member 19 that faces at least a part of the guide member 18. The guide member 18 guides the movement of the mask stage 1. The mask stage 1 (first stage 13) moves with respect to the first opening 9 while being guided by the first surface 11 of the guide member 18, as described above.

The chamber apparatus 6 has, in addition to the first space formation member 7 and the first adjusting apparatus 8, a bellows member 20 for connecting the guide member 18 with the chamber member 19. The bellows member 20 has flexibility and hence is elastically deformable. In the present embodiment the bellows member 20 is made of stainless steel. Stainless steel allows little offgassing (outgassing). Therefore, it is possible to suppress the effect of the bellows member 20 on the first space 5. Note that use of the bellows member 20 is one example. If the effect of outgassing or the like is little, it is possible to use a material other than stainless steel.

The first space formation member 7 has the first opening 9 and the first surface 11, and is configured so as to include the guide member 18 and the chamber member 19. As a result the first space 5 is formed which is substantially hermetically closed by the guide member 18, the chamber member 19, the bellows member 20, and the mask stage 1 (mainly, the first stage 13). The chamber member 19 has an upper surface 19A that faces a lower surface 18B of the guide member 18. The bellows member 20 is arranged so as to connect the lower surface 18B of the guide member 18 with the upper surface 19A of the chamber member 19.

Furthermore, the chamber member 19 includes: a first chamber member 41 for forming a space mainly around the projection optical system PL to set an environment of this space to a predetermined state; and a second chamber member (an environment control apparatus) 42 for forming a space mainly around the substrate stage 2 to set an environment of this space to a predetermined state. The first chamber member 41 and the second chamber member 42 are coupled to each other in a state with the hermeticity thereinside being retained (for example, so that a reduced pressure atmosphere is the first pressure value). In addition, they are separable from each other.

The exposure apparatus EX includes: a base member 21; and a first support member 23 supported on the base member 21 via first antivibration systems 22. The chamber member 19 is supported by the first support member 23. Furthermore, on the base member 21, there is arranged a first frame member 24. The first frame member 24 includes: pillar portions 25; and a support portion 26 connected to tops of the pillar portions 25. To a top of the support portion 26, there is connected a second support member 27 for supporting a lower surface of the guide member 18. The guide member 18 is supported by the first frame member 24 via the second support member 27. The chamber member 19 and the second support member 27 are arranged at positions spaced apart from each other, and hence are prevented from being brought into direct contact with each other. Furthermore, the chamber member 19 and the first frame member 24 are arranged spaced apart from each other, and hence are prevented from being brought into direct contact with each other. Between the chamber member 19 and the first frame member 24, there is arranged a sealing mechanism with flexibility (elasticity) such as a bellows member.

The light source apparatus 3 is a laser produced plasma light source apparatus that generates EUV light by irradiating laser beam onto a target material such as for example xenon (Xe) to plagmatize the target material, that is, a so-called LPP (Laser Produced Plasma) type light source apparatus. Note that as the light source apparatus 3, a discharge produced plasma light source apparatus that generate EUV light by producing discharge in a predetermined gas to plasmatize the predetermined gas, that is, a so-called DPP (Discharge Produced Plasma) type light source apparatus may be used. The EUV light (illumination light) generated by the light source apparatus 3 is incident in the illumination optical system IL via a wavelength selective filter (not shown in the figure). Here, the wavelength selective filter has characteristics of selectively transmitting the EUV light of a predetermined wavelength (for example, 13.4 nm) from the light supplied by the light source apparatus 3, and shielding light of other wavelengths. The EUV light having passed through the wavelength selective filter illuminates the reflective mask (reticle) M on which is formed a pattern to be transferred, via the illumination optical system IL.

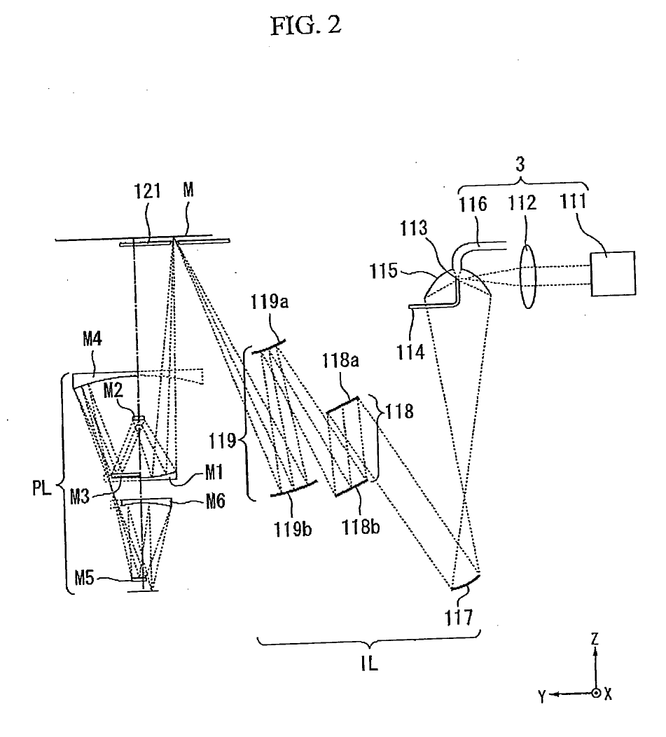

FIG. 2 schematically shows an internal configuration of the light source apparatus 3, the illumination optical system IL, and the projection optical system PL shown in FIG. 1.

The light source apparatus 3 is made of: a laser light source 111; a collective lens 112; a nozzle 114; an ellipsoidal reflecting mirror 115; a duct 116; and the like. Light (non-EUV light) emitted from the laser light source 111 is collected on a gas target 113 via the collective lens 112. The gas target 113 is formed from a high-pressure gas made of for example xenon (Xe) supplied via and sprayed by the nozzle 114. The gas target 113 obtains energy from the collected laser light and is plasmatized to emit EUV light. Note that the gas target 113 is positioned at a first focus of the ellipsoidal reflecting mirror 115.

Therefore, the EUV light emitted from the light source apparatus 3 is collected on a second focus of the ellipsoidal reflecting mirror 115. On the other hand, the gas having finished emitting light is sucked via the duct 116, and is guided to for example the outside of the light source apparatus 3. The EUV light having been collected at the second focus of the ellipsoidal reflecting mirror 115 is guided to tie illumination optical system IL. The illumination optical system IL is made of: a concave reflecting mirror 117; an optical integrator 118; a condenser optical system 119; and the like. The EUV light (illumination light) reflected by the concave reflecting mirror 117 is transformed into a substantially parallel light flux, and is guided to the optical integrator 118. It is configured such that the optical integrator 118 includes a pair of fly's eye optical system (a first fly's eye optical system 118a and a second fly's eye optical system 118b).

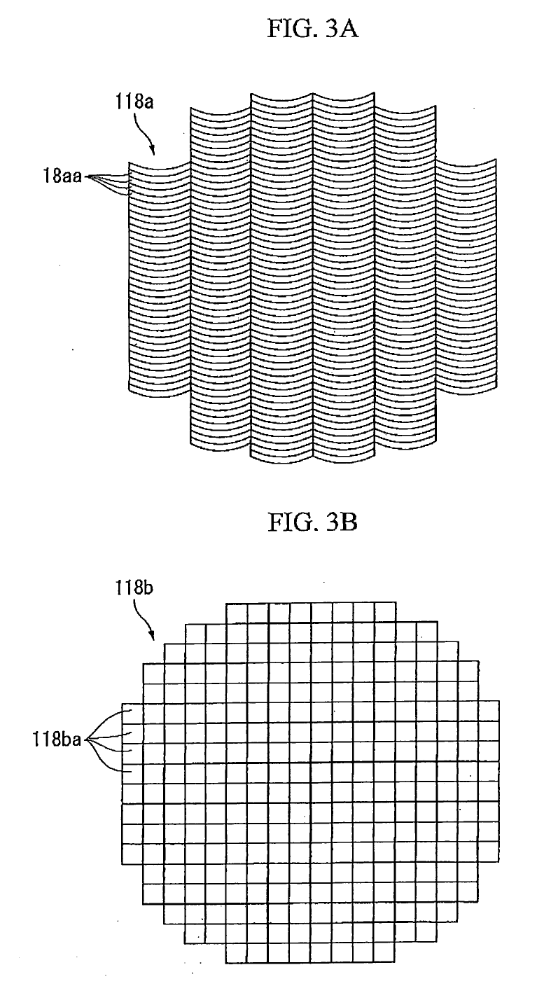

The first fly's eye optical system 118a is made of a plurality of reflecting mirror elements 118aa with an arc-shaped outline arranged in parallel as shown for example in FIG. 3A. The second fly's eye optical system 118b is made of a plurality of reflecting mirror elements 118ba with a rectangular outline arranged in parallel as shown for example in FIG. 3B, corresponding on a one-on-one basis to the plurality of reflecting mirror elements 118aa of the first fly's eye optical system 118a. For the specific configurations and actions of the first fly's eye optical system 118a and the second fly's eye optical system 118b, reference is made to U.S. Pat. No. 6,452,661, the contents of which are incorporated into the present invention by reference as much as possible.

In this manner, in the vicinity of an emission surface of the optical integrator 118, that is, in the vicinity of the reflecting surface of the second fly's eye optical system 118b, there is formed a substantial surface light source with a predetermined shape. The substantial surface light source is formed at an exit pupil position of the illumination optical system IL, that is, a position optically conjugate with an entrance pupil of the projection optical system PL. In the vicinity of reflecting the surface of the second fly's eye optical system 118b, that is, at a formation position of the substantial surface light source, there is arranged an aperture stop AS (not shown in FIG. 2).

The light from the substantial surface light source is emitted from the illumination optical system IL via a condenser optical system 119 that is made of a curved reflecting mirror with a predetermined curvature (a convex reflecting mirror or a concave reflecting mirror) 119a; and a concave reflecting mirror 119b. Here, the condenser optical system 119 is configured such that light beams from a respective reflecting mirror elements of the second fly's eye optical system 118b illuminate the mask M in a superimposing manner. The light (illumination light) emitted from the illumination optical system IL illuminates the mask M via for example an arc-shaped opening part (light transmission portion) of a field stop 121 arranged close to the mask M, an then forms an arc-shaped illumination region on a surface (reflecting surface) of the mask M. The light source apparatus 3 (111 to 116), the illumination optical system IL (117 to 119), and the field stop 121 constitute an illumination system for Koehler illuminating the mask M on which is provided a predetermined pattern.

The light (exposure light EL) including information on an image of the pattern reflected off the illuminated surface (reflecting surface) of the mask M forms an image of a mask pattern in an arc-shaped still exposure region on the substrate P via the projection optical system PL. The projection optical system PL is made of: a first catoptric imaging system for forming an intermediate image of the pattern of the mask M; and a second catoptric imaging system for forming an image of the intermediate image of the pattern of the mask M (a secondary image of the pattern of the mask M) on the substrate P. The first catoptric imaging system is made of four reflecting mirrors M1 to M4. The second catoptric imaging system is made of two reflecting mirrors M5 and M6. Furthermore, the projection optical system PL is an optical system telecentric on the substrate P side (image side).

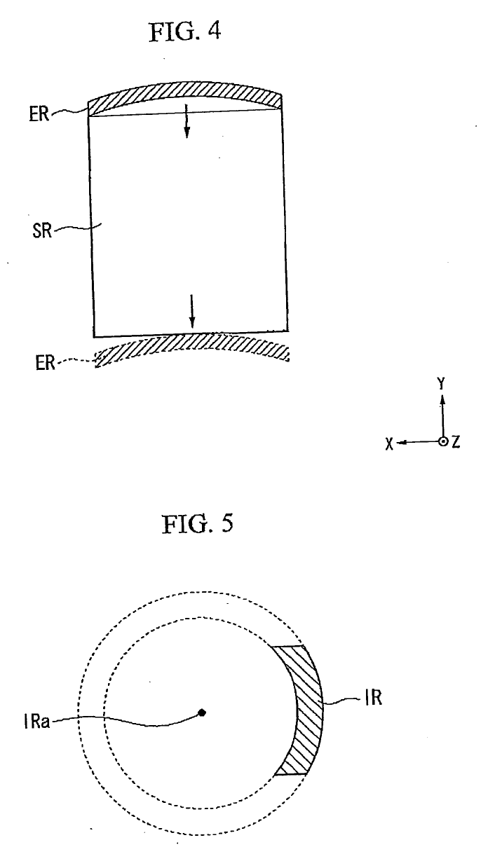

FIG. 4 is a diagram for schematically explaining one scan exposure in the present embodiment. FIG. 4 shows that in the exposure apparatus of the present embodiment an arc-shaped still exposure region (effective exposure region) ER symmetrical about the Y axis is formed so as to correspond to an arc-shaped effective imaging region and an effective field of view of the projection optical system PL. This arc-shaped still exposure region ER, when transferring the image of the pattern of the mask M onto one rectangular shot region SR of the substrate P by using one scan exposure, moves from a scan commencement position shown in the figure with a solid line to a scan completion position shown in the figure with a broken line.

FIG. 5 shows how a rotation axis of an arc shape in an illumination region formed on a mask is defined as a center of a circle that defines an outer arc or an inner arm. In correspondence to the arc-shaped still exposure region ER on the substrate P, there is formed an arc-shaped illumination region IR on the mask M as shown in FIG. 5. A rotation axis IRa of the are shape of the illumination region IR is defined as a center of a circle that defines an outer arc or an inner arc of this arc shape. In the case where the circle that defines the outer arc and the circle that defines the inner arc of the illumination region IR are not coaxial, a middle point between the center of one circle and the center of the other circle may be defined as a rotation axis. Furthermore, in the case where a curve that defines the outer arc or a curve that defines the inner arc of the illumination region IR is not a part of a perfect circle (e.g., that is a part of an ellipse), a center of the ellipse can be regarded as a rotation axis. In the present specification, these are referred to on the whole as “rotation axis of an arc shape.” As will be described later, the rotation axis IRa of the arc shape of the illumination region IR substantially coincides with a pupil axis line that passes through a center of the exit pupil of the illumination optical system and is also perpendicular to a plane of the exit pupil.

Returning to FIG. 1, the plurality of optical elements (reflecting mirrors M1 to M6 and the like of the first and second catoptric imaging systems) that constitute the projection optical system PL are held in a lens barrel 28. The lens barrel 28 has a flange 29. To the flange 29, there is detachably connected lower ends of second frame members 30. Upper ends of the second frame members 30 are connected to the support portion 26 of the first frame member 24 via second antivibration systems 31. The second frame members 30 (and second antivibration systems 31) are arranged at for example three positions in an evenly spaced manner in a circumferential direction, as support members 32 with a flexible structure. They suspend-support the lens barrel 28 (projection optical system PL) from above. Note that the three positions at which the support members 32 are arrange for the lens barrel 28 (projection optical system PL) need not be evenly spaced. For example, based on a center of gravity of the lens barrel 28 (projection optical system PL), the three positions may be determined so that the lens barrel 28 can be supported substantially at this center of gravy.

The projection optical system PL is suspended and supported from a bottom surface of the support portion 26 at three positions via the support members 32 (with a flexible structure). In the present embodiment, a wire is used as the support member 32. However, a chain, a rod where flexure structures are formed respectively in its upper and lower ends, or the like may be used instead. Furthermore, between the support member 32 and the support portion 26, the second antivibration system 31 (antivibration portion) is provided for reducing vibration in the Z direction, which is an optical axis direction of the projection optical system PL. The support portion 26, the support members 32, and the second antivbration systems 31 are included in a suspend-support member for suspend-supporting the projection optical system PL.

In this configuration, a relative position of the mask stage 1 and the substrate stage 2 with respect to the projection optical system PL is measured. Therefore, it is configured such that the mask stage 1 and the substrate stage 2 are always capable of controlling the positions with high accuracy with reference to the projection optical system PL.

Incidentally, as a length L of the support portion 26 is shorter, the value of an eigenfrequency fg in a direction perpendicular to an optical axis of the projection optical system PL is smaller, the eigenfrequency fg is represented as follows:

f_{g}=(g/L)^{1/2}/(2π) tm (1)

where g is a gravitational constant.

The smaller this eigenfrequency fg is, the more a vibration isolation performance in the direction perpendicular to the optical axis of the projection optical system PL improves. Therefore, to improve the vibration isolation performance, the longer the length L of the link member is, the better. However, to stably support the projection optical system PL, it is preferable that the flange 29, which is to be suspended from the support members 32, be fixed in the vicinity of the center of gravity of the unit as a whole to be suspended. Furthermore, to downsize the exposure apparatus as much as possible, it is preferable that the height of the upper end of the support portion 26 be to a degree not over the upper end of the projection optical system PL. Therefore, in the present embodiment, the length L of the support member 32 is equal to approximately ½ of the length in the Z axis direction of the projection optical system PL or shorter.

The substrate stage 2 and a face plate JB are arranged in the interior of the first space 5. The substrate stage 2 holds the substrate P so that the surface (exposure surface) of the substrate P is substantially parallel to the XY plane. Furthermore, the substrate stage 2 holds the substrate P so that the surface of the substrate P faces in the +Z direction. The exposure light EL emitted from the projection optical system PL is irradiated onto the substrate P held in the substrate stage 2.

The substrate stage 2 is movable in six directions of: the X axis, the Y axis, the Z axis, and the θX, θY, and θZ directions with respect to the face plate JB, in a condition holding the substrate P. The driving apparatus (not shown in the figure) for moving the substrate stage 2 is fixed on for example the face plate JB. In the present embodiment, there are provided: a laser interferometer (not shown in the figure) capable of measuring position information of the substrate stage 2 (substrate P); and a focus leveling detection system (not shown in the figure) capable of detecting surface position information of the substrate P. The control apparatus 4 controls the position of the substrate P which is held in the substrate stage 2 based on the detection results of the laser interferometer 4L and the detection results of the focus leveling detection system.

Furthermore, these substrate stage 2 and face plate JB are movable in the Y direction as a stage unit into which the antivibration systems 22, the first support member 23, and the chamber member 42 separated from the chamber member 41 are integrated. As a moving method at this time, a method may be adopted, for example, where when the drive of the antivibration systems 22 is halted, a hover it (not shown in the figure) provided on the lower surface (the surface on the −Z side) of the first support member 23 is activated to make the first support member hover (levitate) with respect to the base member 21 and then to move it in a contact-free manner.

The aforementioned first space formation member 7 supports, as a frame according to the present invention, the projection optical system PL via the support members 32. In addition, it forms, for example in the first space 5 surrounded by the four pillar portions 25 arranged at vertex portions of the rectangle in the plan view of the exposure apparatus EX, an accommodation portion 5A for accommodating the substrate stage 2 and the face plate JB. The accommodation portion 5A is formed between the projection optical system PL in the first space 5 and the base member 21 as a floor portion. Furthermore the first space formation member 7 forms, on the +Y side of the accommodation portion 5A, an opening portion 5B that communicates with the accommodation portion 5A. This open portion 5B is formed between the base member 21 and a beam portion 43 that is disposed between the two pillar portions 25 arranged in the +Y direction in a substantially parallel manner. This beam portion 43 is provided movably with respect to the support portions 25, which will be described later.

The exposure apparatus EX includes a plurality of actuators (driving apparatus) for finely adjusting the XY position of the projection optical system PL with respect to the base member 21. The plurality of (three, in the present embodiment) actuators are arranged so as to correspond to positions (three locations) at which the respective support members 32 are arranged for the lens barrel 28 (projection optical system PL) on a one-on-one basis.

As the driving apparatus, one that drives the projection optical system PL in a contact-free manner is preferable. However, it is not particularly limited thereto. The present embodiment uses voice coil motors in which a coil unit and a magnet unit cooperate to generate the Lorentz force, which is used as a driving force. A stator 44A (for example, a coil unit) of at least one of the three voice coil motors is supported on the beam portion 43. On the flange 29 of the projection optical system PL, there is supported a mover 44B (for example, a magnet unit) of the corresponding voice coil motor so as to face the stator 44A. As a result, the stator 44A (coil unit) and the mover 44B (magnet unit) cooperate to generate the Lorentz force.

Here, the height (the distance between a lower surface of a beam portion 43 and the upper surface of the base member 21) H of the opening portion 5B is set to be larger than the length (height) LP of the projection optical system PL. Furthermore, the height H of the opening portion 5B is set to be larger than the length LB in a height direction between the surface of the substrate P held in the substrate stage 2 and the base member 21. Furthermore, a gap LA in the height direction between a pattern formation surface (surface on the −Z side) of the mask M held in tilt mask stage 1 and the surface of the substrate P held in the substrate stage 2 is set to be smaller than the length LB.

Still furthermore, the length (height) LP of the projection optical system PL is set to be smaller than the length LB in a height direction between the surface of the substrate P held in the substrate stage 2 and the base member 21. Note that if the projection optical system PL is allowed to be inclined slightly, the dimensional relationship is not limited to the relationship described above. For example, the height (distance between the lower surface of the beam portion 43 and the upper surface of the base member 21) H of the opening portion 5B may be set to be equal to or slightly smaller than the length (height) LP of the projection optical system PL.

The opening portion 5B need not be necessarily provided in the exposure apparatus EX. It is essential only that the projection optical system PL be allowed to pass through as required. For example, it may be configured such that the opening portion is set by removing a predetermined member of the exposure apparatus EX.

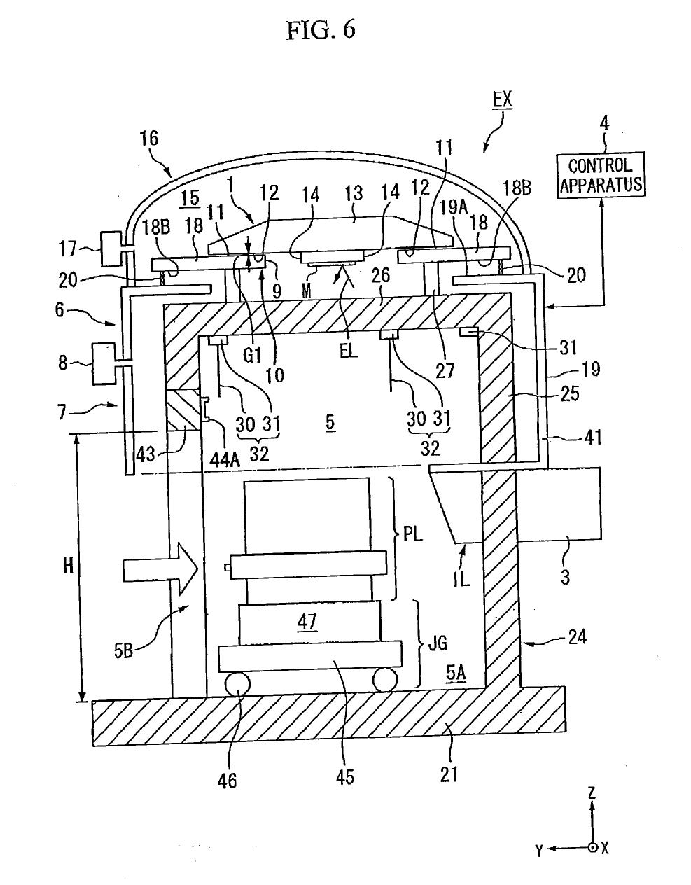

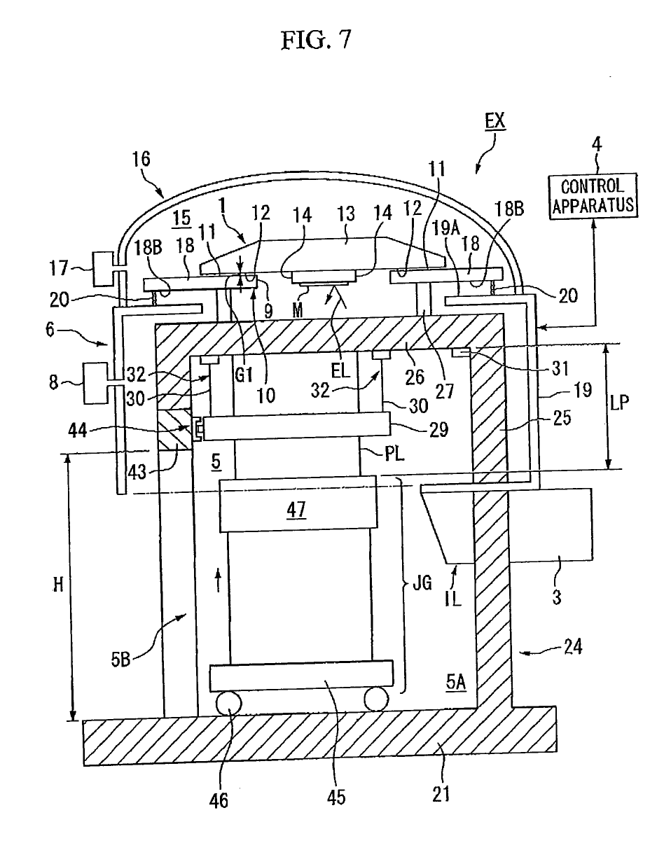

Next is a description of a procedure of suspend-supporting the projection optical system PL of the above exposure apparatus EX at a predetermined suspension position with respect to for example the support portion 26, taking the time when the exposure apparatus EX is manufactured as an example, with reference to FIG. 1, FIG. 6, and FIG. 7.

Note that the suspension position may be any position of the projection optical system PL that is allowed when the exposure apparatus EX is established as a product, and is not necessarily specified at one point. For example, it is configured such that the projection optical system PL is movable with a predetermined stroke within the XY plane (in the X direction, the Y direction, and about θZ) by the actuator (driving apparatus 44). Therefore, as long as the projection optical system PL is within this stroke, it follows that it is positioned in its predetermined position. In the present embodiment, the suspension position is described as a position at which the projection optical system PL and the support members 32 are connected within the stroke for suspend-supporting the projection optical system PL.

First, a jig JG that is used to tort the projection optical system PL will be described.

As shown in FIG. 6, the jig JG has: a base 45 with wheels 46 that are rollingly movable on the base member 21; and a lifting apparatus 47 that is provided on the base 45 and extends/contracts in the Z direction with respect to the base 45. The jig JG is capable of traveling on the base member 21 by rollingly moving the wheels 46. Here, to support from below means a case where, for example, the center of gravity of the jig JG within the XY plane and the center of gravity of the projection optical system PL within the XY plane are in the near each other, as is distinguished from the case where the projection optical system PL is supported by a cantilever member as in a forklift truck.

With the extension/contraction of the lifting apparatus 47, it is possible to move up and down the projection optical system PL supported by the jig JG for example between a height position corresponding to the suspension position and a height position that allows the projection optical system PL to pass through the opening portion 5B without causing interference with the beam portion 43.

Before the projection optical system PL is suspend-supported, the chamber members 41, 42 are separated. At this time, the stage unit made of: the substrate stage 2, the face plate JB, the antivibration systems 22, the first support member 23, and the chamber member 42 is not yet arranged in the accommodation portion 5A. Then, as shown in FIG. 6, the projection optical system PL is mounted onto the jig JG. Subsequently, with the lifting apparatus 47 being contracted, the jig JG is traveled on the base member 21 to position the projection optical system PL at a position directly under the exposure position in the accommodation portion 5A.

Next, the lifting apparatus 47 is extended, to thereby move the projection optical system PL upward from below while it is supported from below by the jig JG. Then, as shown in FIG. 7, the projection optical system PL is positioned at the exposure position (positioning step). Then, the flange 29 of the projection optical system PL having been moved to the suspension position is connected to the second frame members 30 to cause the projection optical system PL to be suspend-supported by the support members 32 (support step). After that the position of the projection optical system PL in the XY directions may be finely adjusted by driving the driving apparatus 44. When the projection optical system PL is thus suspend-supported at the suspension exposure position, the stage unit is accommodated in the accommodation portion 5A, and the chamber member 42 is coupled to the chamber member 41. This completes the installation of the projection optical system PL.

On the other hand, when the projection optical system PL is removed and carried out from the exposure apparatus EX for the purpose of maintenance or the like, the procedure reverse to the above is followed.

To be more specific, firstly, the chamber members 41, 42 are separated, and a hover unit or the like is used to take out the stage unit, which is made of: the substrate stage 2, the face plate JB, the antivibration systems 22, the first support member 23, and the chamber member 42, from the accommodation portion 5A of the first space formation member 7 via the opening portion 5B. Next, after the jig JG (without the projection optical system PL thereon) is traveled and carried into the accommodation portion 5A from which the stage unit has been taken out, the lifting apparatus 47 is ascended to cause the jig JG to support the projection optical system PL from below. Then, in this condition, the projection optical system PL having been suspend-supported is disconnected from the second frame members 30. As a result, the projection optical system PL is mounted onto the jig JG.

When the projection optical system PL is mounted onto the jig JG, the lifting apparatus 47 is contacted to move the projection optical system PL downward. Then, when the projection optical system PL is descended to a height that does not cause interference with the beam portion 43, the jig JG is moved along the XY plane (the base member 21), and is taken out from the accommodation portion 5A, with the projection optical system PL mounted thereon.

As a result, even after the projection optical system PL is built in the exposure apparatus EX, it is possible to perform a maintenance treatment or the like on the projection optical system PL with ease.

Note that when the projection optical system PL is returned to its original suspend-supported state after completion of the maintenance treatment or the like, the positioning step and the support step similar to those described above may be performed.

Next is a description of one example of an operation of the exposure apparatus EX with the above configuration.

The first space 5 is adjusted to a vacuum state (first pressure value) by means of the first adjusting apparatus 8. Furthermore, the second space 15 is adjusted, by means of the second adjusting apparatus 17, to a pressure (second pressure value) which is substantially the same as that of the first space 5 or which is higher than that of the first space 5 and is lower than the atmospheric pressure. Alternatively, it may be configured such that the second space 15 is set to a pressure lower than that of the first space 5. The gap G1 between the first surface 11 and the second surface 12 is adjusted to a predetermined amount by means of a gap adjustment mechanism 35. Therefore, flow of the gas to the inside of the first space 5 is suppressed by the gas sealing mechanism 10 formed between the first surface 11 and the second surface 12. As a result the vacuum state and environment of the first space 5 is maintained.

After the mask M is held in the mask stage 1 and the substrate P is held in the substrate stage 2, the control apparatus 4 starts an exposure process of the substrate P. To illuminate the mask M with the illumination light, the control apparatus 4 starts a light emission operation of the light source apparatus 3.

The EUV light emitted from the light source apparatus 3 through the light emission operation of the light source apparatus 3 is incident in the illumination optical system IL. The EUV light incident in the illumination optical system IL, after traveling through the illumination optical system IL, is supplied to the first opening 9. The EUV light having been supplied to the first opening 9 is incident as illumination light on the mask M held in the mask stage 1 via the first opening 9. That is, the mask M held in the mask stage 1 is illuminated with the illumination light (EUV light) emitted from the light source apparatus 3 and having passed through the illumination optical system IL. The illumination light irradiated onto the reflecting surface of the mask M and reflected off the reflecting surface is incident, as exposure light EL including information on the image of the pattern of the mask M, in the projection optical system PL arranged in the first space 5. The exposure light EL incident in the projection optical system PL, after traveling through the projection optical system PL, is irradiated onto the substrate P held in the substrate stage 2.

In synchronous with the movement of the mask M in the Y axis direction, the control apparatus 4 illuminates the mask M with the exposure light EL while moving the substrate P in the Y axis direction. As a result, the substrate P is exposed with the exposure light EL, and the image of the pattern of the mask M is projected onto the substrate P.

As described above, according to the present embodiment, when the projection optical system PL is positioned, the projection optical system PL is moved upward from below. This eliminates the necessity of using large-scale transport equipment for inserting the projection optical system PL from above the first space formation member 7. As a result, it is possible to reduce the amount of effort and cost needed, and is also possible to avoid a multitude of restrictions in the building where the exposure apparatus EX is installed, such as securing a height of the ceiling. Furthermore, in the present embodiment, the projection optical system PL is moved upward while being supported from below. Therefore, it is possible to move the projection optical system PL with stability and ease. Especially, in the present embodiment, the projection optical system PL is moved via the accommodation portion 5A in which the substrate stage 2 is accommodated. This eliminates the necessity of additionally providing a space for installing transport equipment. Therefore, it is possible to contribute to space saving, and is made possible to use a compact jig JG excellent in operability. As a result, it is possible to significantly improve workability.

Furthermore, in the present embodiment, when the projection optical system PL is removed for a maintenance treatment or the like, the projection optical system PL is moved downward. This eliminates the necessity of inserting the projection optical system PL from above in a manner cantilevered from above, and hence the necessity of large-scale transport equipment. Therefore, it is possible to reduce the amount of effort and cost needed. Furthermore, also in the maintenance method of the present embodiment, it is possible to stably move the projection optical system PL because when moved downward, the projection optical system PL is supported from below. Especially, in the present embodiment the projection optical system PL is moved via the accommodation portion 5A in which the substrate stage 2 is accommodated. This eliminates the necessity of additionally providing a space for installing transport equipment. Therefore, it is possible to contribute to space saving, and use a compact jig JG excellent in operability. As a result, it is possible to significantly improve workability.

### Second Embodiment

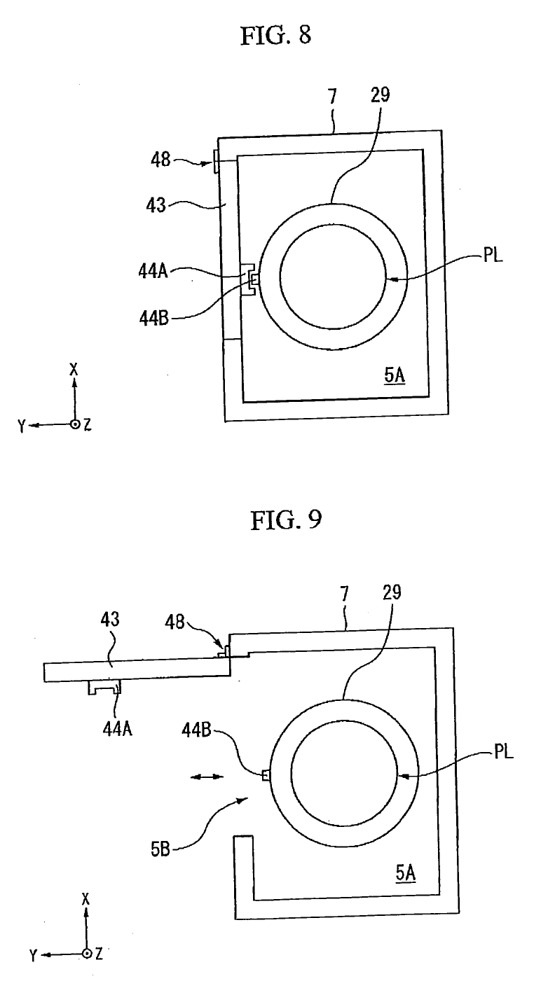

Next is a description of a second embodiment of an exposure apparatus and a manufacturing method thereof, and of a maintenance method of the exposure apparatus, with reference to FIG. 8 to FIG. 10.

Note that in these figures, constituent parts similar to those of the first embodiment shown in FIG. 1 to FIG. 7 are designated with like reference numerals and are not repetitiously explained.

FIG. 8 and FIG. 9 are plan views showing a cross-section of FIG. 1, taken along the A-A line.

In the present embodiment, the beam portion (support frame) 43, provided with the stator 44A of the driving apparatus 44 (only one of the three is shown), that forms a part of the first space formation member 7 is rotatably provided about the Z axis with respect to the other parts of the first space formation member 7 by means of a hinge portion 48. That is, the beam portion 43 in the present embodiment is freely opened/closed with respect to the first space formation member 7. It is configured such that when it is closed, the beam portion 43 supports the stator 44A at a position facing the mover 44B, as shown in FIG. 9, and that when it is opened, the opening portion 5B (accommodation portion 5A) is opened with a front opening larger (in dimension in the X, Z directions) than Me flange 29, as shown in FIG. 9.

In the other points, the configuration is similar to that of the above first embodiment.

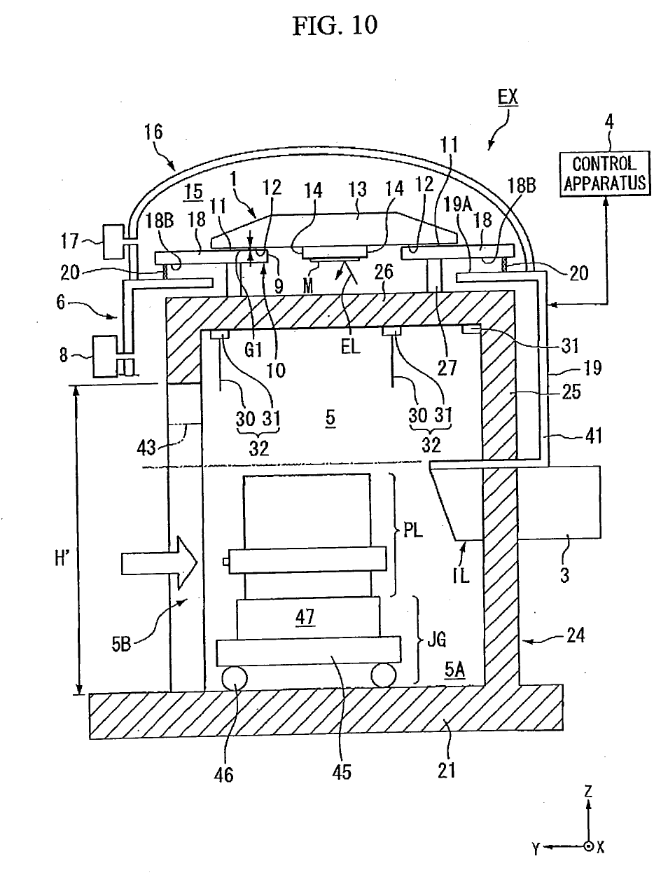

In the exposure apparatus EX with the above configuration, opening the beam portion 43 makes a height H′ of the opening portion 5B larger by the thickness of the beam portion 43 as shown in FIG 10. As a result, when the projection optical system PL is taken out from the exposure apparatus EX (accommodation portion 5A), and when the projection optical system PL is accommodated in the accommodation portion 5A, it is not necessary to descend the lifting apparatus 47 to a height that allows the projection optical system PL mounted on the jig JG to pass through the opening portion 5B but that does not cause the projection optical system PL to interfere with the beam portion 43.

Therefore, in the present embodiment, it is possible to obtain the actions and advantages similar to those of the above first embodiment. In addition, it is possible to shorten a movement stroke when the projection optical system PL is moved downward from the suspension position to the carry-out position (a height that allows passage through the opening portion) by the jig JG in a state with the projection optical system PL being supported from below at the time of the manufacture or maintenance of the exposure apparatus EX, and a movement stroke when the projection optical system PL is moved upward to the suspension position after it is carried into the accommodation portion 5A. This shortens the manufacturing time and the maintenance time, and contributes to improvement in manufacturing efficiency and production efficiency.

While exemplary embodiments of the invention have been described above with reference to the accompanying drawings, obviously these are not to be considered as limitative of the invention. Shapes, combinations and the like of the constituent members illustrated above are merely examples, and various modifications based on design requirements and the like can be made without departing from the spirit or scope of the invention.

For example, in the above embodiments, it is configured such that tile jig JG with the lifting apparatus 47 is used to move the projection optical system PL downward or upward. However, the invention is not limited to this. It may be configured such that a jig for moving the projection optical system PL with the projection optical system PL being suspended with the flange 29 (in a state with the projection optical system PL being supported from above) is used.

The projection optical system PL has been described as one that is suspend-supported by the support members 32. However, the invention is not limited to such a configuration. For example, it may be configured such that the projection optical system PL is held by the pillar portions 25 from its circumference at a position of the center of gravity of the projection optical system PL in the Z direction. Also in this case, it is configured such that the projection optical system PL is removed after it is moved downward from the position at which it is supported. Furthermore, also in the manufacture of the exposure apparatus EX, the projection optic system PL is positioned at a predetermined position, and then the projection optical system PL is supported at that position. In its positioning, the projection optical system PL is moved upward from below.

Furthermore, in the above embodiments, it is configured such that the substrate stage 2 as a stage unit integrated with the chamber member 42 is taken out from/accommodated in the accommodation portion 5A. However, the invention is not limited to this. For example, it may be configured such that the substrate stage 2 is taken out/accommodated together with the face plate JB.

Furthermore, it may be configured such that the whole of the mask stage 1 is arranged in the first space 5, without providing the second space 15.

Note that as for the substrate (object) of each of the above embodiments, not only a semiconductor wafer for manufacturing a semiconductor device, but also a glass substrate for a display device, a ceramic wafer for a thin film magnetic head, a master mask or reticle (synthetic quart or silicon wafer), film member, and similar can be used. Moreover, substrates are not limited to round shape, but may be rectangular or other shapes.

As for the exposure apparatus EX, in addition to a scan type exposure apparatus (scanning stepper) in which while synchronously moving the mask M and the substrate P, the pattern of the mask M is scan-exposed, a step-and-repeat type projection exposure apparatus (stepper) in which the pattern of the mask M is exposed at one time in the condition that the mask M and the substrate P are stationary, and the substrate P is successively moved stepwise can be used. Furthermore, the present invention an be applied to a step-and-stitch type exposure apparatus in which at least two patterns are transferred in a partially overlapping manner.

Furthermore, the present invention can also be applied to an exposure apparatus or the like as disclosed for example in U.S. Pat. No. 6,611,316, which combines patterns of two masks on a substrate via a projection optical system, and double exposes a single shot region on the substrate at substantially the same time, through a single scan exposure.

The types of exposure apparatuses EX are not limited to exposure apparatuses for semiconductor element manufacture that expose a semiconductor element pattern onto a substrate P, but are also widely applicable to exposure apparatuses for the manufacture of liquid crystal display elements and for the manufacture of displays, and exposure apparatuses for the manufacture of thin film magnetic heads, image pickup devices (CCDs), micro machines, MEMS, DNA chips, and reticles or masks.

Furthermore, in the present embodiments, the description has been given of an example where the exposure light EL is EUV light. However, for the exposure light EL, for example emission lines (g-line, h-line, i-line), radiated for example from a mercury lamp, deep ultraviolet beams (DUV light beams) such as the KrF excimer laser beam (wavelength: 248 nm), and vacuum ultraviolet light beams (VUV light beams) such as the ArF excimer laser beam (wavelength: 193 nm) and the F2 laser beam (wavelength: 157 nm), may be used. In this case, the first space 5 need not be adjusted to a vacuum state. For example, the first space 5 may be filled with a first gas. In the case where the first space 5 is filled with the first gas, it is possible to use the gas sealing mechanism 10 of the present embodiments in order to maintain the environment of the first space 5 filled with the first gas. Furthermore, the second space 15 formed of the second member 16 may be filled with a second gas.

Furthermore, the present invention can also be applied to a twin stage type exposure apparatus provided with a plurality of substrate stages (wafer stages). A configuration and an exposure operation of a twin stage type exposure apparatus is disclosed for example in Japanese Patent Application Publication No. H10-163099A and Japanese Patent Application Publication No. H10-214783A (corresponding to U.S. Pat. Nos. 6,341,007, 6,400,441, 6,549,269, and 6,590,634), Published Japanese Translation No. 2000-505958 of PCT International Application (corresponding to U.S. Pat. No. 5,969,411), or U.S. Pat. No. 6,208,407. Moreover, the present invention may be applied to a wafer stage of Japanese Patent Application No. 2004-168481 that the present applicants have filed before.

Furthermore, the exposure apparatus EX is manufactured by assembling various subsystems, including the respective constituent elements, so that the prescribed mechanical precision, electrical precision and optical precision can be maintained. To ensure these respective precisions, performed before and after this assembly, adjustments made to achieve are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes, for example, mechanical connections, electrical circuit wiring connections, and air pressure circuit piping connections, etc. among the various subsystems. Obviously, before the process of assembly from these various subsystems to the exposure apparatus, there are processes of individual assembly of the respective subsystems. When the process of assembly to the exposure apparatuses of the various subsystems has ended, overall assembly is performed, and the various precisions are ensured for the exposure apparatus as a whole. Note that it is preferable that the manufacture of the exposure apparatus be performed in a clean room in which, for example, the temperature, and the degree of cleanliness are controlled.

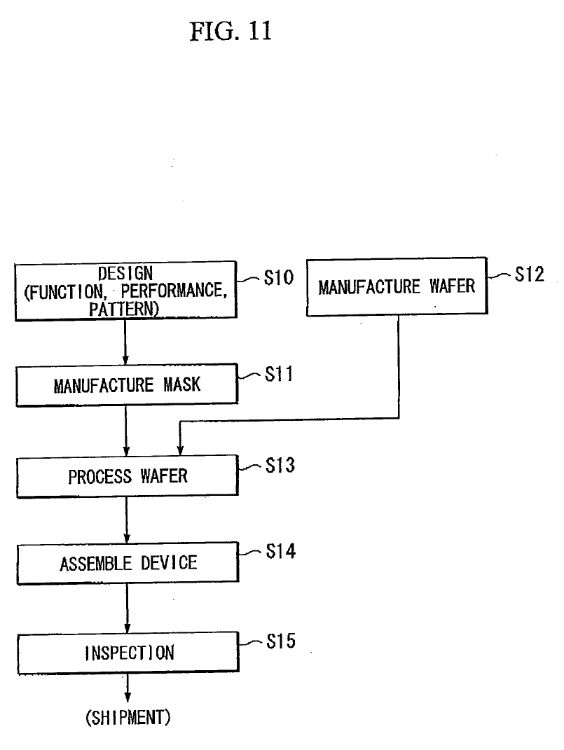

Next is a description of an embodiment of a micro device manufacturing method by using, in the lithography process, the exposure apparatus and the exposure method according to the embodiments of the present invention. FIG. 11 is a flow chart showing a manufacturing example of micro devices (semiconductor chips such as ICs and LSIs, liquid crystal panels; CCDs; thin film magnetic heads; micro machines; and the like).

First, in a step S10 (design step), micro device function and performance design (for example, circuit design of a semiconductor device, or the like) is performed, and pattern design for implementing the function is performed. Subsequently, in a step S11 (mask fabrication step), a mask (reticle) on which the designed circuit pattern is formed is fabricated. In the mean time, in a step S12 (wafer manufacturing step), a wafer is manufactured using a material such as silicon.

Next, in a step S13 (wafer processing step), the mask and the wafer prepared in the step S10 to the step S12 are used to form an actual circuit and the like on the wafer by the lithography technique or the like. Subsequently, in a step S14 (device assembly step), the wafer processed in the step S13 is used to assemble a device. This step S14 includes, as required, steps such as a dicing step, a bonding step and a packaging step (chip inclusion). Finally, in a step S15 (inspection step), inspections such as an operation check test and an endurance test are performed on the micro device fabricated in the step S14. After these steps, the micro device is finished, and is shipped.

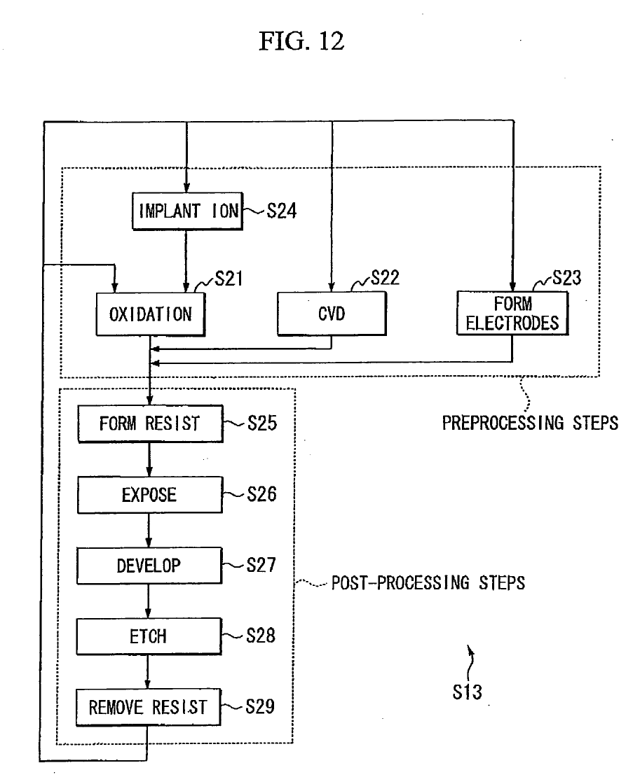

FIG. 12 shows one example of detailed steps of the step S13 in the case of a semiconductor device.

In a step S21 (oxidation step), the surface of the wafer is oxidized. In a step S22 (CVD step), an insulation film is formed on the water surface. In a step S23 (electrode formation step), electrodes are formed on the wafer by vapor deposition. In a step S24 (ion implantation step), ion is implanted into the wafer. Each of the above step S21 to step S24 functions as a preprocessing step in the respective stages of the wafer process. They are selected and performed in accordance with the required processing in the respective stages.

On completion of the above preprocessing steps in the respective stages of the wafer process, post-processing steps are performed as follows. In these post-processing steps, firstly a photosensitive material is spread on the wafer in a step S25 (resist formation step). Subsequently, in a step S26 (exposure step), the circuit pattern of the mask is transferred onto the wafer by the above-described lithography system (exposure apparatus) and exposure method. Next, in a step S27 (development step), the exposed wafer is developed. In a step S28 (etching step), an exposed member in the portions other than the portion where the resist remains is removed by etching. Then, in a step S29 (resist removal step), the resist which has become needless after the etching is removed. With the repetition of these preprocessing steps and post-processing steps, multiple circuit patterns are formed on the wafer.

Furthermore, the present invention can be applied not only to a micro device such as a semiconductor element, but also to an exposure apparatus that transfers a circuit pattern from a mother reticle to a glass substrate, a silicon wafer, or the like in order to manufacture a reticle or a mask for use in a light exposure apparatus, an EUV exposure apparatus, an X-ray exposure apparatus, an electron beam exposure apparatus, or the like. Here, in an exposure apparatus that uses DUV (deep ultraviolet) light, VUV (vacuum ultraviolet) light, or the like, a transmissive reticle is used in general, and as a reticle substrate, silica glass, silica glass doped with fluorine, fluorite, magnesium fluoride, crystal, or the like is used. Furthermore, in an X-ray exposure apparatus, an electron beam exposure apparatus, or the like based on a proximity system, a transmissive mask (stencil mask, membrane mask) is used, and as a mask substrate, a silicon wafer or the like is used. Note that such exposure apparatuses are disclosed in PCT International Publication No. WO 99/34255, PCT International Publication No. WO 99/50712, PCT International Publication No. WO 99/66370, Japanese Patent Application Publication No. H11-194479A, Japanese Patent Application Publication No. 2000-12453A, Japanese Patent Application Publication No. 2000-29202A, and the like.

In one or more embodiments, in order to position the projection optical system in the positioning step, the projection optical system is moved upward from below. For example, the projection optical system can be ascended from an installation space for a substrate stage that is installed below the projection optical system. As a result, it is possible to move the projection optical system which is, for example, supported on both sides or from below, and not in a cantilevered manner. Therefore, large-scale transport equipment can be redundant for carrying in and out, compared with the case in which the installation of the projection optical system has a downward movement. As a result, it is possible to position the projection optical system with ease by maws of a small-scale jig. The flexible structure can be a light and inexpensive structure compared with a rigid structure. Thereby, it is also possible to obtain a favorable characteristic of suppressing transmission of vibration or thermal change. Therefore, it is possible to reduce the effect of vibration on the projection optical system.

In one or more embodiments, the un-installation of the projection optical system has a downward movement. For example, the projection optical system can be moved down toward an installation space for a substrate stage that is installed below the projection optical system. As a result, the projection optical system can be moved while, for example, being supported on both sides or from below, and not in a cantilevered manner. Therefore, large-scale transport equipment can be redundant for carrying in and out, compared with the case in which the installation of the projection optical system has a downward movement. As a result it is possible to unistall the projection optical system with ease by means of a small-scale jig.

In one or more embodiments, it is possible to uninstall the projection optical system released from the support by the support member by moving downward, and to take and carry the projection optical system out of the support structure via the opening portion by moving in a horizontal direction. Therefore, large-scale transport equipment can be redundant for carrying in and out, compared with the case in which the installation of the projection optical system has a downward movement. As a result, it is possible to uninstall and move out the projection optical system with ease by means of a small-scale jig.

1. A manufacturing method of an exposure apparatus that uses a projection optical system to project an image of a pattern, the method comprising:
upwardly moving the projection optical system to position the projection optical system at a predetermined position; and
supporting the positioned projection optical system.

2. The manufacturing method of the exposure apparatus according to claim 1, wherein the positioning comprises supporting the projection optical system from below.

3. The manufacturing method of the exposure apparatus according to claim 2, wherein the positioning further comprises providing a lifting apparatus that freely travels in a horizontal direction and that supports the projection optical system from below.

4. The manufacturing method of the exposure apparatus according to claim 1, wherein the supporting comprises providing a support member that has a flexible structure and by which the projection optical system is suspended and supported.

5. The manufacturing method of the exposure apparatus according to claim 1, wherein
the exposure apparatus comprises: a substrate stage that moves while holding a substrate onto which the image of the pattern is projected; and a support structure provided with an accommodation portion that supports the projection optical system and accommodates the substrate stage, and
in the positioning, the projection optical system is moved upward via the accommodation portion.

6. The manufacturing method of the exposure apparatus according to claim 5, wherein the positioning further comprises: taking out the substrate stage from the accommodation portion before the projection optical system is moved upward via the accommodation portion; and accommodating the substrate stage in the accommodation portion after the projection optical system is positioned.

7. The manufacturing method of the exposure apparatus according to claim 6, wherein the substrate stage is taken out from and accommodated in the accommodation portion in a state in which the substrate stage is in united state with an environment control apparatus that controls an environment around the substrate stage.

8. The manufacturing method of the exposure apparatus according to claim 5, wherein
the projection optical system is driven by a driving apparatus that generates a driving force through cooperation between a first member and a second member, one of the first member and the second member being provided in the projection optical system, the other of the first member and the second member being supported, at a position facing the one member, by a movable member capable of moving with respect to the support structure, and
the method further comprises facing the first member with the second member by setting the movable member and the support structure in a predetermined positional relationship.

9. A maintenance method of an exposure apparatus that uses a projection optical system to project an image of a pattern, the method comprising
uninstalling the projection optical system from the exposure apparatus, the un-installation comprising downwardly moving the projection optical system supported by a support member.

10. The maintenance method of the exposure apparatus according to claim 9, wherein the un-installation farther comprises supporting the projection optical system from below.

11. The maintenance method of the exposure apparatus according to claim 10, wherein the un-installation further comprises providing a lifting apparatus that freely travels in a horizontal direction and that support the projection optical system from below.

12. The maintenance method of the exposure apparatus according to claim 9, wherein the projection optical system is suspended by a support member with a flexible structure so as to be positioned at a predetermined position.

13. The maintenance method of the exposure apparatus according to claim 9, wherein
the exposure apparatus comprises: a substrate stage that moves while holding a substrate onto which the image of the pattern is projected; and a support structure provided with an accommodation portion that supports the projection optical system via the support member and accommodates the substrate stage, and
the downwardly moving comprises moving the projection optical system in the accommodation portion.

14. The maintenance method of the exposure apparatus according to claim 13, wherein the un-installation further comprises: taking out the substrate stage from the accommodation portion before the projection optical system is moved to the accommodation portion; and horizontally moving the projection optical system at the accommodation portion.

15. The maintenance method of the exposure apparatus according to claim 14, wherein the substrate stage is carried in and out from the accommodation portion in a state in which the substrate stage is in united state with an environment control apparatus that controls an environment around the substrate stage.

16. The maintenance method of the exposure apparatus according to claim 13, wherein
the projection optical system is driven by a driving apparatus that generates a driving force through cooperation between a first member and a second member, one of the first member and the second member being provided in the projection optical system, the other of the first member and the second member being supported, at a position facing the one member, by a movable member capable of moving with respect to the support structure, and
the horizontal movement comprises forming an opening portion via which the projection optical system is horizontal moved with the movable member and the support structure being set in a predetermined positional relationship.

17. An exposure apparatus that uses a projection optical system to project an image of a pattern, comprising:
a support structure that supports a projection optical system; and
an opening portion via which the projection optical system is carried out in a horizontal direction, the opening portion being located lower than the projection optical system supported by the support structure.

18. The exposure apparatus according to claim 17, further comprising:
a mask holding apparatus that holds a mask with a surface on which the pattern is formed; and
a substrate holding apparatus that holds a substrate onto which the image of the pattern is projected,
wherein a distance in a height direction between the surface on which the pattern of the mask held in the mask holding apparatus is formed and a surface of the substrate held in the substrate holding apparatus is smaller than a distance in a height direction between the surface of the substrate and a floor portion.

19. The exposure apparatus according to claim 17, wherein a width in a height direction of the opening portion is larger than a length in a height direction of the projection optical system.

20. The exposure apparatus according to claim 19, wherein the length in a height direction of the projection optical system is smaller than a distance in a height direction between the surface of the substrate and the floor portion.

21. The exposure apparatus according to claim 17, wherein the support structure suspends and supports the projection optical system by means of a support member with a flexible structure.

22. The exposure apparatus according to claim 20, wherein the substrate holding apparatus can be freely moved in and out from the support structure via the opening portion.

23. The exposure apparatus according to claim 22, wherein the substrate holding apparatus is freely moved in and out from the support structure in a state in which the substrate holding apparatus is in united state with an environment control apparatus that controls an environment around the substrate holding apparatus.

24. The exposure apparatus according to claim 17, further comprising:
a driving apparatus that drives the projection optical system; and a movable member capable of moving with respect to the support structure,
wherein the driving apparatus comprises a first member and a second member that cooperate to generate a driving force, one of the first member and the second member being provided in the projection optical system, the other of the first member and the second member being supported, at a position facing the one member, by the movable member.
